(19) United States
(12) Patent Application Publication
(10) Pub. No.: US 2007/0006689 A1
(43) Pub. Date: Jan. 11, 2007

(54) Offset crank speed wrench with lever arm

(76) Inventor: Helmer A. Carlson, Lethbridge (CA)

Correspondence Address: WILLIAM J BUNDREN;THE LAW OFFICE OF WILLIAM J BUNDREN, 734 LaRue Road, Millersville, MD, 21108, US

(21) Appl. No.: 11/179,020

(22) Filed: Jul. 11, 2005

(51) Int. Cl. B25B 23/16; B25G 1/00

(52) U.S. Cl. 81/73; 81/177.1; 81/177.4

(57) ABSTRACT

An offset crank speed wrench with a lever arm that extends laterally and perpendicularly of the axis of rotation of the wrench is provided. The arm may integrally attach, be detachable or pivot at its point of attachment. The wrench can have one or more swivel-like joints that permit the wrench to be moveable in a way to increase leverage.

### FIELD OF THE INVENTION

The present invention relates to offset crank speed wrenches, specifically to offset crank speed wrenches with a lever arm to increase the torque that can be exerted by the offset crank speed wrench.

### BACKGROUND OF THE INVENTION

The use of an offset crank speed, wrench in the course of any specific task generally requires the wrench generate varying amounts of torque throughout the task. For example, more torque will be required during the initial stages of unlocking a nut that has been tightly fastened onto a bolt. Once the nut begins to unfasten less torque will generally be needed.

Generally, offset crank speed wrenches are used in applications where high rotational speed is desirable. As such, they are designed to have a small and fixed moment arm. As a result, a way to increase the torque generated by the offset crank speed wrench is to increase the amount of force being applied to the offset crank speed wrench. If not enough force can be applied to the offset crank speed wrench, the offset crank speed wrench may not generate the torque required for the task, for example, when a nut has been fastened tightly onto a bolt.

It is, therefore, desirable to have a means of increasing the moment arm of an offset crank speed wrench so that greater torque can be generated from the same force.

### SUMMARY OF THE INVENTION

It is an object of the present invention to provide means for attaching a lever arm to an offset crank speed wrench that enables increased torque to be generated by the offset crank speed wrench for any given amount of force.

According to one aspect of the present invention, there is provided leverage means in the form of an arm, associated with an offset crank speed wrench. The arm increases leverage exerted on the offset crank speed wrench, thereby increasing the torque for any given force.

In one embodiment, the arm may be fixed in place. In another embodiment, the arm may pivot so that it is able to lie against the other portions of the offset crank speed wrench and out of the way when not in use. In yet another embodiment, the arm may attach and detach from the offset crank speed wrench, depending on whether it is in use or not. The point of contact between the arm and the offset crank speed wrench is configured such that the rotational force being applied to the handle is transferred to the offset crank speed wrench.

According to another aspect of the present invention, the offset crank speed wrench includes a nut formed thereon and the arm includes a wrench adapted to engage the nut for transmitting a rotational force to turn the speed wrench.

According to another aspect of the present invention, portions of the offset crank speed wrench become the lever arm. There is provided one or more pivoting points along portions of the offset crank speed wrench such as a swivel. The swivel allows the general shape of the offset crank speed wrench to be altered so that portions of the wrench become the lever arm. The lever arm is positioned laterally away from the axis of rotation in an extended configuration, thereby increasing the moment arm of the speed wrench and imparting increased leverage thereto.

The present invention provides an offset crank speed wrench which comprises an offset crank handle carrying socket means configured to accommodate a fastener for transmitting a rotational force thereto. Lever means is associated with the offset crank handle for turning the speed wrench. The lever means being operatively arranged on the crank handle such that a force applied to the lever means is transmitted to the crank handle for increased leverage.

### BRIEF DESCRIPTION OF THE DRAWINGS

The present invention will now be described by way of examples with reference to the following figures wherein:

FIG. 1 is a side view of an offset crank speed wrench integrally connected to an arm in accordance with an embodiment of the present;

FIG. 2 is a side view of an offset crank speed wrench pivotally connected to an arm in an extended position for use in accordance with another embodiment of the present invention;

FIG. 3 is a side view of an offset crank speed wrench pivotally connected to an arm in a retracted position in accordance with another embodiment of the present invention;

FIG. 4 is a side view of an offset crank speed wrench having a bore and an arm received in the bore in accordance with another embodiment of the present invention;

FIG. 5 is a side view of an offset crank speed wrench having a nut adapted to received wrench means in accordance with another embodiment of he present invention;

FIG. 6 is a side view of an offset crank speed wrench having a swivel portion in a normal configuration in accordance with another embodiment of the present invention; and

FIG. 7 is a side view of an offset crank speed wrench having a swivel portion in an extended configuration to impart increased torque in accordance with another embodiment of the present invention.

### DETAILED DESCRIPTION OF THE PREFERRED EMBODIMENT

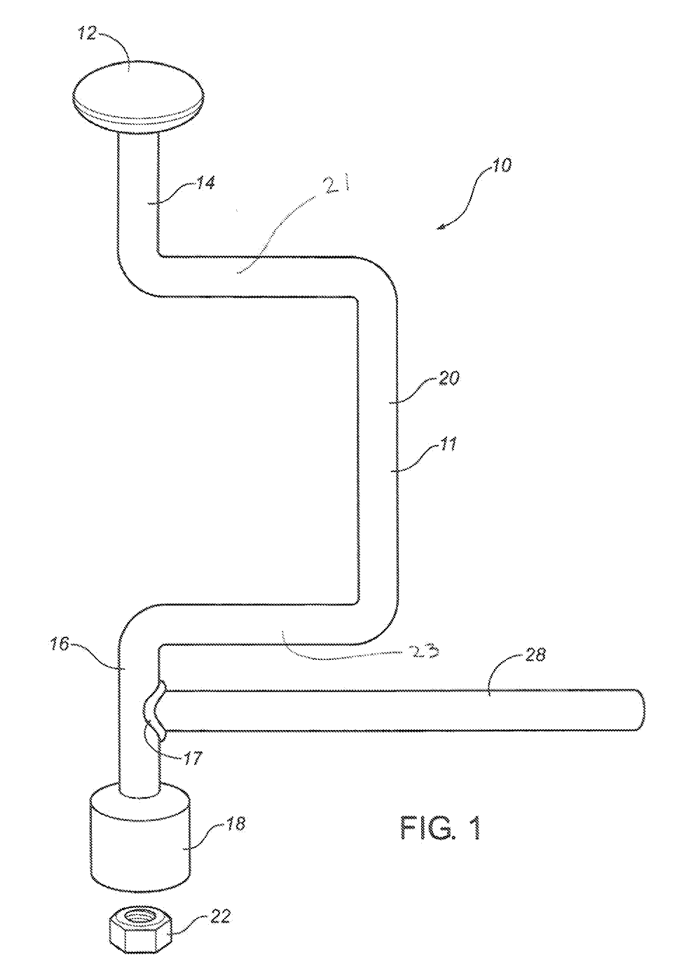

Referring now to FIG. 1, which shows an offset crank speed wrench 10 in accordance with one aspect of the present invention. Offset crank speed wrench 10 is, preferably, a standard offset crank speed wrench known to those skilled in the art. Offset crank speed wrench 10 generally includes an offset crank handle 11, which carries socket means 18 for receiving a fastener in the form of a nut 22.

Socket means 18 may be integrally formed on offset crank speed wrench 10 or it may be a detachable socket that releasably couples with offset crank speed wrench 10 as well known to those skilled in the art. Offset crank handle 11 may be turned by the user to impart a rotational force to socket means 18 to rotate nut 22.

Offset crank handle 11 of speed wrench 10 includes a rotary portion 12 for hand placement, an upper crank member 14, a lower crank member 16 and a socket portion 18 adapted to receive a fastener such as nut 22. Socket portion 18 can be configured to receive any type of fastener known to those skilled in the art.

Upper crank member 14 and lower crank member 16 are mutually aligned in the axial plane of offset crank speed wrench 10. An offset portion 20, positioned away from the central axis of the mutually aligned crank members, connects upper crank member 14 and lower crank member 16. Offset portion 20 provides for hand placement.

In operation, the user typically places the hands on rotary portion 12 and offset portion 20 to turn speed wrench 10 in the desired direction and cause axial rotation of speed wrench 10 for loosening or tightening fastener 22.

In one aspect of the invention, lever means are provided in the form of an arm 28, which is integrally formed on lower crank member 16. Arm 28 can be in the form of a pipe, an extension handle, a wrench or the like. Arm 28 extends generally outwardly and perpendicularly of the axis of rotation of lower crank member 16 of speed wrench 10. Arm 28 may also be positioned anywhere along the axial length of offset crank handle 11 of speed wrench 10, such that a force being applied to arm 28 is transmitted to crank handle 11 for increased leverage. A weld 17, or other means for integrally connecting arm 28 to wrench 10, is formed between arm 28 and lower crank member 16.

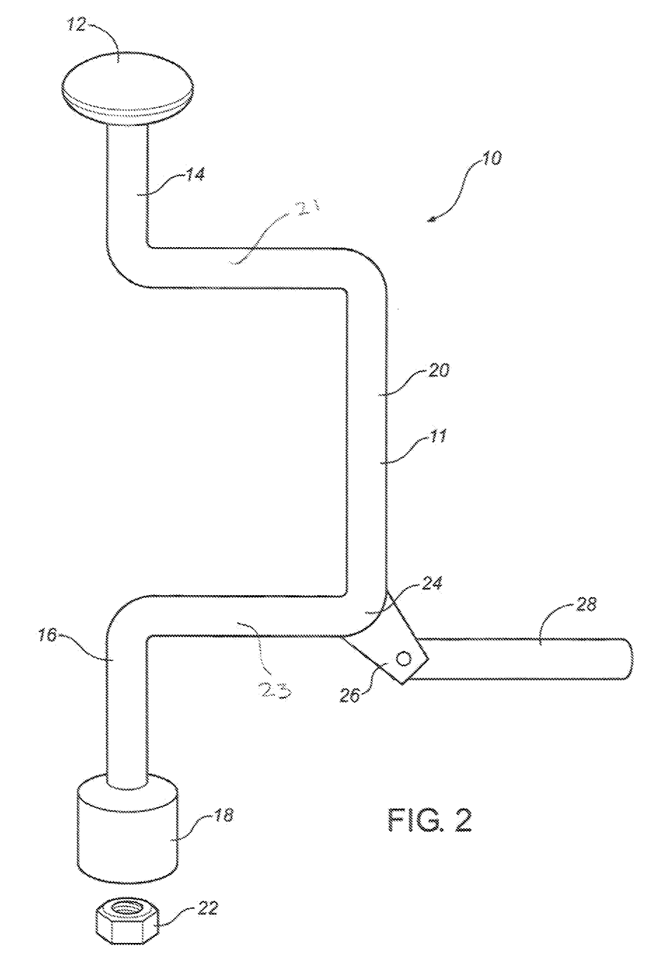

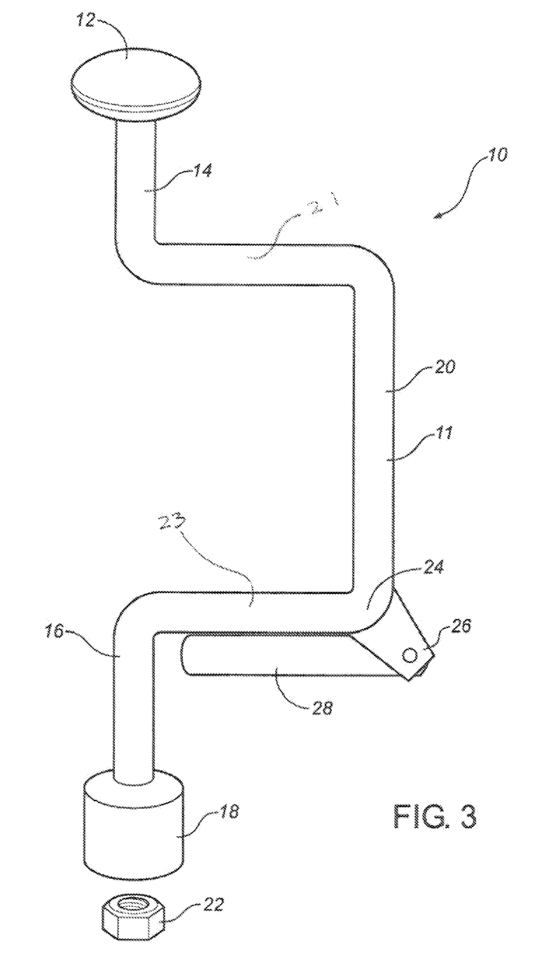

FIG. 2 shows offset crank speed wrench 10 being pivotally connected to arm 28 in an extended position for use. A pivoting mechanism 26 such as an elbow, joint or the like is preferably associated with a lower curved section 24 of offset portion 20 of wrench 10. Arm 28 pivots on pivoting mechanism 26 to move it between a retracted position, out of the way for storage (FIG. 3), and an extended position for use (FIG. 2). In the extended position, a force may be applied to the extended arm 28 by the user, to turn offset crank handle 11 in the desired direction.

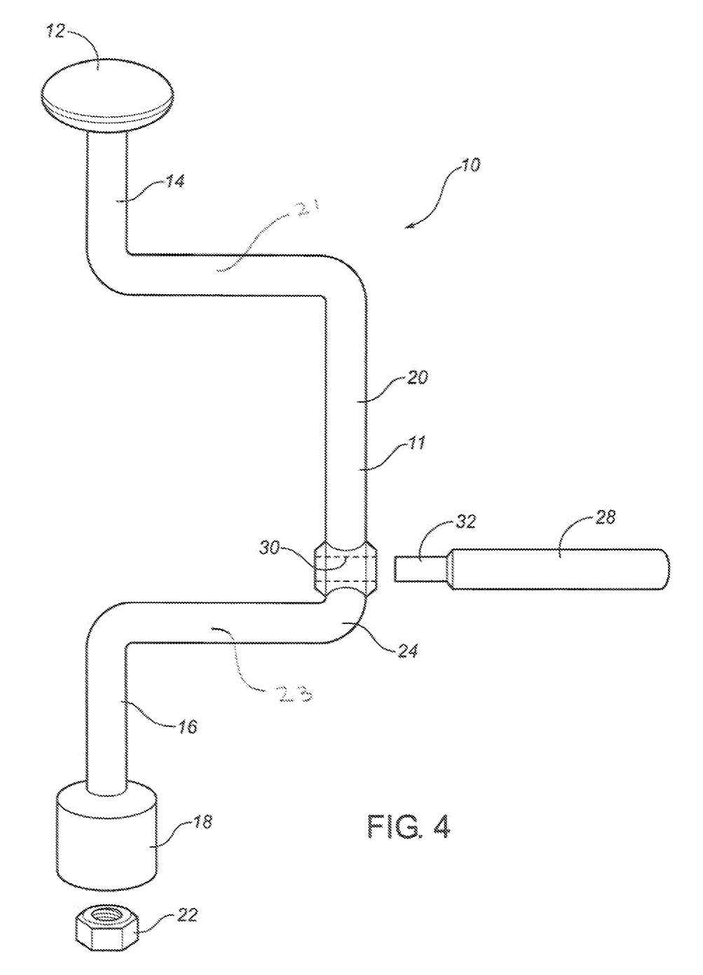

FIG. 4 shows offset crank speed wrench 10 having a bore 30, preferably located at lower curved section 24 of offset portion 20 of offset crank handle 11. Bore 30 may extend through offset crank handle 11. Arm 28 is configured in such a manner to be detachably received within bore 30 and secure thereto for transmitting the rotational force. Preferably arm 28 is a pipe or the like carrying a tapered section 32, which is sized and shaped to removably secure within bore 30 in sliding fit.

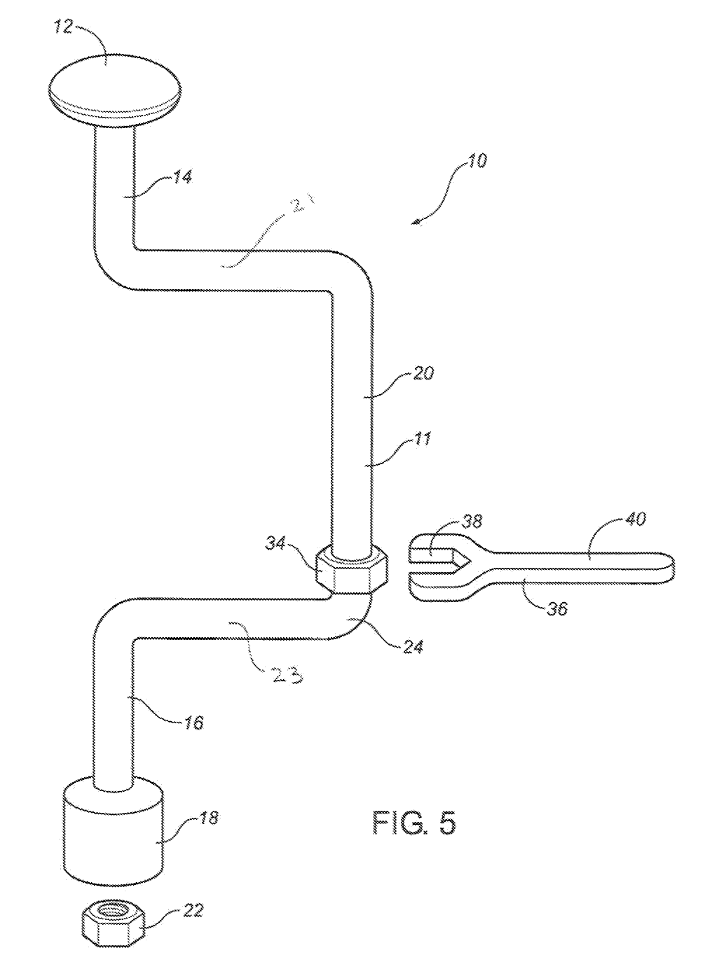

FIG. 5 shows offset crank speed wrench 10 in accordance with another aspect of the invention. Speed wrench 10 comprises lever means in the form of a nut 34 adapted to received wrench means 36 to transmit the rotational force to offset crank handle 11. Nut 34 may be a typical nut, a squared-off portion or the like known to those skilled in the art. Nut 34 is preferably associated with lower curved section 24, but may be operationally located anywhere along the length of crank handle 11. Wrench means 36 may be a typical wrench or an adjustable wrench or the like well known to those skilled in the art. Wrench 36 comprises a wrench mouth 38 that is fitted around nut 34 and a wrench handle 40 for the placement of a user's hand to impart a rotational force to nut 34, thereby turning crank handle 11. It is preferred that the size, shape and composition of the material of nut 34 is dependent on the intended application of offset crank speed wrench 10. If for example, heavy-duty application is intended, speed wrench 10 may be manufactured with nut 34 having a larger size and stronger metal composition. If, however, light-duty application is intended, speed wrench 10 may be engineered to incorporate nut 34 that is configured smaller and/or formed using a lightweight material composition.

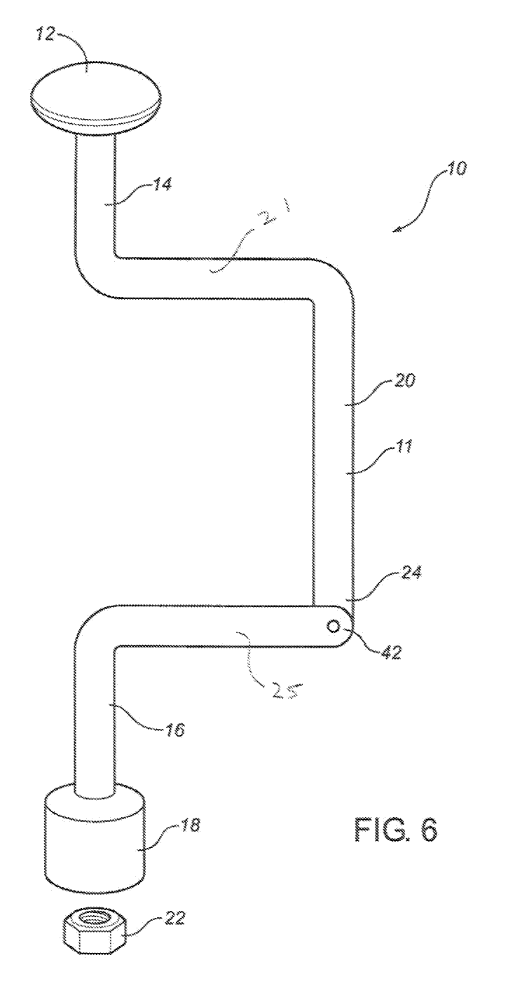

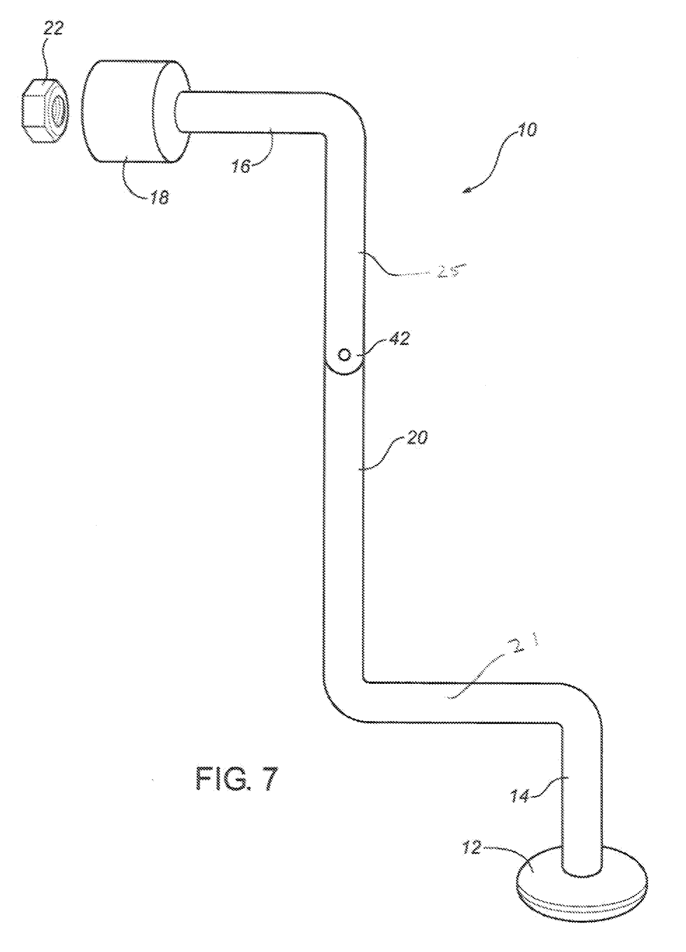

FIGS. 6 and 7 show offset crank speed wrench 10 having a swivel portion 42 in a normal configuration and in an extended configuration, respectively. At least one swivel portion 42 may be formed on lower curved section 24 of offset portion 20 of offset crank handle 11. However, swivel portion 42 may be located anywhere along the length of offset crank handle 11 so as to allow movement of a portion of offset crank handle 11 laterally away from the axis of rotation, thereby forming lever means for increasing the leverage imparted on speed wrench 10 (FIG. 7). The extended configuration, wherein lever means is extended substantially outwardly and perpendicularly of the axis of rotation of offset crank handle 11, may be returned to the normal configuration (shown in FIG. 6) via swivelling action of offset crank handle 1 1.

Although preferred embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized at the scope of the invention as defined and limited only by the claims that follow.

1. An offset crank speed wrench comprising:
a) mutually aligned upper and lower crank members defining a central axis, said lower crank member configured at one end to receive a fastener for transmitting a rotational force thereto;
b) an offset crank handle operatively connected to said upper and lower crank members via upper and lower connectors, said handle offset being generally parallel to said central axis, said upper and lower connectors substantially perpendicular to said central axis, and
c) a lever associated with said handle, said lever being operatively arranged on said handle such that said lever extends generally outwardly and perpendicularly from said handle, said lever extending generally parallel to said lower connector whereby a force applied to said lever is transmitted thereto for increased leverage to turn said speed wrench.

2. (canceled)

3. An offset crank speed wrench as recited in claim 1, wherein said lever is integrally formed with said handle

4. An offset crank speed wrench as recited in claim 3, wherein said lever is fixedly attached to said handle.

5. An offset crank speed wrench as recited in claim 1, wherein said handle further comprises a bore formed therein, said bore configured for receiving said lever.

6. An offset crank speed wrench as recited in claim 5, wherein said lever further comprises an extension arm having one end configured to detachably engage said bore.

7. An offset crank speed wrench as recited in claim 1, wherein t said lever comprises a wrench and said handle comprises a wrench receiving element thereto, said wrench receiving element being configured to accept said wrench.

8. An offset crank speed wrench as recited in claim 1, wherein said handle further comprises an arm pivotally associated with a portion of said handle, said arm being moveable from a retracted position to an extended position for turning said speed wrench.

9. (canceled)
